(19) United States
(12) Patent Application Publication
(10) Pub. No.: US 2026/0210091 A1
(43) Pub. Date: Jul. 23, 2026

(54) HEAT-DRIVEN ATMOSPHERIC WATER GENERATOR

(71) Applicant: SIMON FRASER UNIVERSITY, Burnaby (CA)

(72) Inventor: Majid BAHRAMI, North Vancouver (CA)

(21) Appl. No.: 19/144,269

(22) PCT Filed: Jan. 10, 2024
(86) PCT No.: PCT/CA2024/050027

§ 371 Date: Jun. 27, 2025

Related U.S. Application Data
(60) Provisional application No. 63/479,415, filed on Jan. 11, 2023.

(51) Int. Cl. E03B 3/28; B01D 51/10; B01D 53/04; B01D 53/06; B01D 53/26

(52) U.S. Cl. CPC E03B 3/28; B01D 51/10; B01D 53/0438; B01D 53/0446; B01D 53/0454; B01D 53/06; B01D 53/261; B01D 53/265; B01D 2257/80; B01D 2259/40098

(57) ABSTRACT

A heat-driven atmospheric water generator includes a preconditioner, a secondary atmospheric water generator, and a core atmospheric water generator. The preconditioner is configured to increase temperature and moisture content of ambient air, providing increased moisture-containing air. The secondary atmospheric water generator is fluidly coupled to the preconditioner to receive the increased moisture-containing air and configured to reduce the air temperature and humidity by heat exchange with cooled air, providing a reduced moisture-content air and producing condensed liquid water. The core atmospheric water generator having an inlet fluidly coupled to the secondary atmospheric water generator to receive the reduced moisture-content air and configured to further reduce temperature and humidity, producing condensed liquid water and the cooled air that is utilized in the secondary atmospheric water generator.

### FIELD OF TECHNOLOGY

The present disclosure relates to atmospheric water generators for the extraction of water from air.

### BACKGROUND

With increasing population, urbanization, and industrialization, global water consumption by humans is increasing each year.

Freshwater is utilized for agriculture, energy production, industrial fabrication, as well as human and ecosystem needs. Water quality and accessibility of clean water are particularly important in all aspects of society and industry including, the domestic, energy, medical, mining, and industrial sectors, to name a few. Variations of global water withdrawal by the domestic sector between 1950 and 2010 indicate that global domestic water usage has risen by a factor of 3.7, which equals to an average annual growth rate of 2.2% over that period.

The distribution of freshwater around the globe is not even, leading to regional shortages or excesses of water resources. Based on the Falkenmark Stress Indicator (FSI), which classifies a country in different categories of water shortage based on per capita liquid water resource availability (PWR), many countries are expected to experience water stress or scarcity by 2025.

Due to existence of hardly removable toxic compounds released from industrial effluents and agricultural pesticide run-offs to the surface or underground water resources, conventional drinking water treatment methods based on coagulation-flocculation, sedimentation, sand filtration, disinfection, ozonation, and desalination are not completely effective in producing suitable water for the domestic sector. Furthermore, as a result of utilization of different chemicals in these treatment procedures for removing suspended materials and for disinfection, several carcinogenic and mutagenic byproducts may result that are hazardous for human health.

As a result of global drought propagation as well as the challenges and shortcomings of convention drinking water treatment systems and methods, atmospheric water generation systems have emerged. Atmospheric water generators (AWG) operate based on a vapor compression refrigeration (VCR) process to extract water from air by cooling and dehumidification.

The atmosphere surrounding the earth is estimated to contain a total of over 12.9E12 m³ of renewable water. This volume is even greater than the total available freshwater in marshes, wetlands, and rivers around the world. Based on the information from manufacturers of AWGs, however, the cost of harvesting 1 liter of water is expensive, typically more than 30 times that of common desalination systems. Furthermore, current AWGs experience a significant drop in production in dry regions or during less humid periods or days due to low performance of vapor compression refrigeration (VCR) units of AWGs.

The poor performance in dry regions results in inadequate water production. It is therefore desirable to improve water generation, even in dry regions.

U.S. Pat. No. 661,944 to E. S. Belden discloses an AWG unit using vapor compression refrigeration (VCR), i.e., an air conditioning system that condenses water from air by cooling it below the dew point temperature. FIG. 1 shows a schematic diagram of an AWG 100 using the vapor compression refrigeration cycle. The compressor 102 sucks the refrigerant gas from the evaporator 104 and after compression, discharges the high pressure and temperature gas toward the condenser 106. Through the condenser, the gas is condensed as a result of heat rejection to a secondary flow such as air or water, and a saturated or sub-cooled liquid goes to the expansion valve 108. As a result of throttling through the expansion valve 108, the pressure and temperature of the refrigerant drops and a low pressure and temperature two-phase refrigerant flows into the evaporator 104. The cooling effect of a VCR cycle occurs in the evaporator through which the refrigerant evaporates. This evaporation results in heat absorption from air stream flowing around the evaporator coil that cools the air stream below the dew point temperature and leads to water generation. Several companies are now producing the AWG units for use in residential and commercial applications. These AWG units, however, exhibit poor performance in dry regions or during dry periods due to significantly lower dew point temperature and water content in the ambient air. There is demand for water generation in these dry regions due to water resource scarcity.

Improvements in water generation are desirable.

### SUMMARY

According to an aspect of an embodiment, a heat-driven atmospheric water generator includes a preconditioner, a secondary atmospheric water generator, and a core atmospheric water generator. The preconditioner is configured to increase temperature and moisture content of ambient air, providing increased moisture-containing air. The secondary atmospheric water generator is fluidly coupled to the preconditioner to receive the increased moisture-containing air and configured to reduce the air temperature and humidity by heat exchange with cooled air, providing a reduced moisture-content air and producing condensed liquid water. The core atmospheric water generator having an inlet fluidly coupled to the secondary atmospheric water generator to receive the reduced moisture-content air and configured to further reduce temperature and humidity, producing condensed liquid water and the cooled air that is utilized in the secondary atmospheric water generator.

### BRIEF DESCRIPTION OF THE DRAWINGS

Embodiments of the present disclosure will now be described, by way of example only, with reference to the attached figures, in which:

FIG. 1 is a schematic diagram of a prior art atmospheric water generator (AWG);

FIG. 2 is a schematic diagram of a heat-driven atmospheric water generator in accordance with an aspect of the present invention;

FIG. 3 is a schematic diagram of a preconditioner of the heat-driven atmospheric water generator of FIG. 2, in accordance with one embodiment;

FIG. 4 shows an example of a solid sorbent composite used in a sorption/desorption unit of the preconditioner of FIG. 3;

FIG. 5 shows an example of a surface modification and a liquid sorbent of a sorption/desorption unit of the preconditioner of FIG. 3;

FIG. 6 is a schematic diagram of a secondary atmospheric water generator of the heat-driven atmospheric water generator of FIG. 2;

FIG. 7 shows an example of a surface modification utilized in the heat-driven atmospheric water generator FIG. 6;

FIG. 8 is a schematic diagram of a core atmospheric water generator of the heat-driven atmospheric water generator of FIG. 2;

FIG. 9 shows an example of enhancement features of a surface in the heat-driven atmospheric water generator of FIG. 8;

FIG. 10 is a schematic diagram of an alternative preconditioner of the heat-driven atmospheric water generator of FIG. 2, in accordance with another embodiment;

FIG. 11 is a schematic diagram of an alternative core atmospheric water generator of the heat-driven atmospheric water generator of FIG. 2, in accordance with another example embodiment.

### DETAILED DESCRIPTION

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

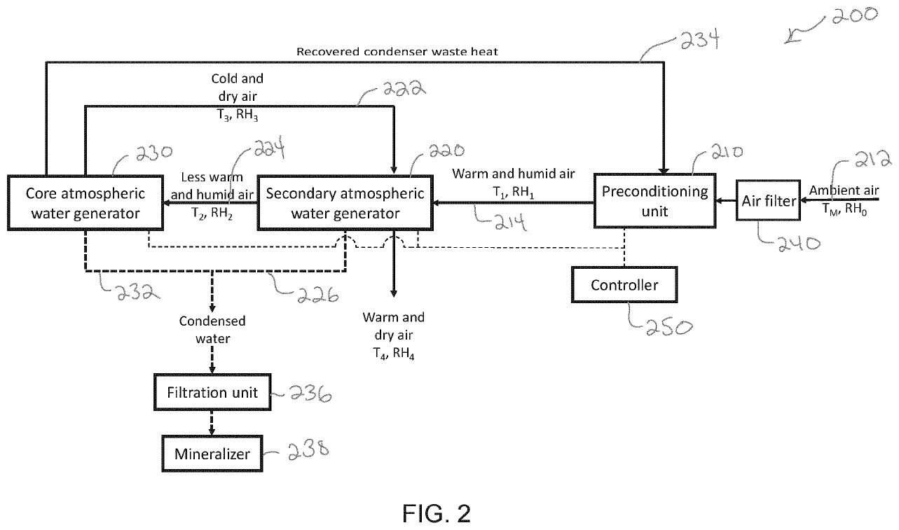

Reference is made to FIG. 2, which shows a schematic diagram of a heat-driven atmospheric water generator, indicated generally by the numeral 200. The heat-driven atmospheric water generator 200 includes a preconditioner 210 configured to increase the moisture content and, optionally, temperature, of ambient air 212, providing increased moisture-containing air 214. An air filter 240 is be utilized to filter the incoming ambient air 212 and to reduce the chance of fouling of the preconditioner 210. Thus, the ambient air is filtered prior to introduction to a secondary atmospheric water generator 220 and a core atmospheric water generator 230, to reduce the chance of fouling the condensing surfaces of the secondary atmospheric water generator 220 and core atmospheric water generator. The secondary atmospheric water generator 220 is fluidly coupled to the preconditioner 210, to receive the increased moisture-containing air 214 and is configured to reduce the air temperature and condense humidity from the increased moisture-containing air 214 by heat exchange with cooled air 222, or ambient air under conditions in which the ambient air is cooler than the increased moisture-containing air 214, providing a reduced temperature and moisture-content air 224 and producing condensed liquid water 226. A core atmospheric water generator 230 has an inlet fluidly coupled to the secondary atmospheric water generator 220 to receive the reduced moisture-content air 224 and configured to further reduce temperature and condense humidity, producing liquid water 232. In addition, the core atmospheric water generator 220 produces the cooled air 222 that is utilized in the secondary atmospheric water generator 220 and heated fluid 234, such as heated air or heated water, which may be utilized in the preconditioning unit 210.

The condensed liquid water 226 from the secondary atmospheric water generator 220 and the condensed liquid water 232 from the core atmospheric water generator 230 may optionally be filtered in a filtration unit 236 and subjected to mineralization in a mineralizer 238, providing water that may be utilized for drinking purposes or agriculture usage.

A controller 250 is connected to components including valves of the preconditioner 210, the secondary atmospheric water generator 220, and the core atmospheric water generator 230. The controller 250 may also be coupled to one or more sensors including an ambient air temperature sensor and ambient air moisture content sensor. Additional sensors may be coupled to the controller 250 to monitor operating parameters or conditions of one or more of the preconditioner 210, the secondary atmospheric water generator 220, and the core atmospheric water generator 230.

The controller 250 is configured to control the components including the valves of the preconditioner 210, the secondary atmospheric water generator 220, and the core atmospheric water generator 230, as well as fans or pumps utilized to control the speed of the flow of air such as the ambient air, heated air, moisture containing air, and cooled air, and the speed and flow of other heating and cooling fluids such as, for example, water, or glycol, utilized in the heat-driven atmospheric water generator 200, based on the demand as well as the atmospheric conditions detected utilizing the sensors, and the operating parameters or conditions detected utilizing the sensors as well as weather forecast in advance.

The operating parameters may include one or more of the speed of one or more fans or pumps, cooling and heating capacity of one or more heat exchangers of the preconditioner, capacity of one or more heat exchangers of the secondary atmospheric water generator, speed of a desiccant wheel such as that described below, and capacity of the core atmospheric water generator.

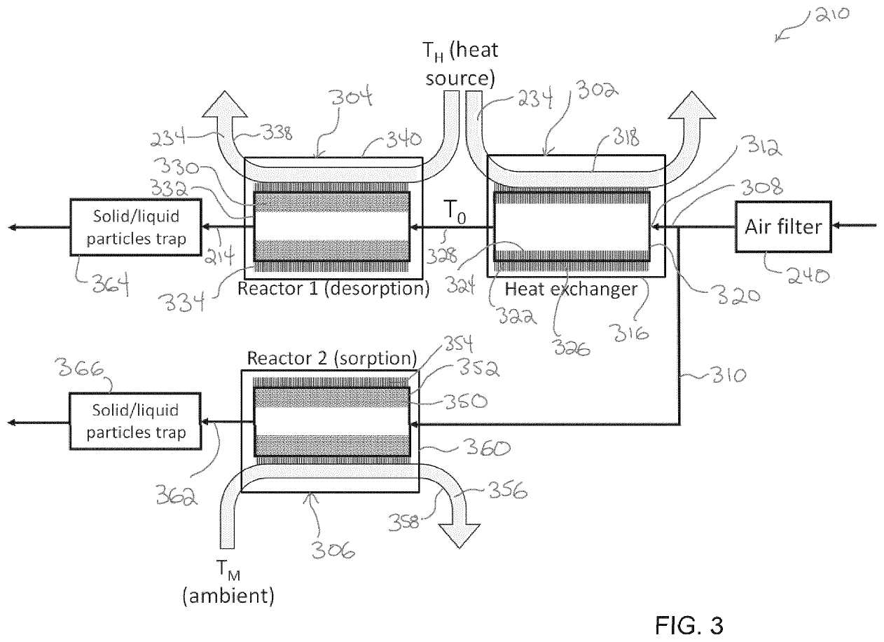

The preconditioner 210 is utilized to increase the humidity content of the ambient air 212. A schematic diagram of one example of the preconditioner 210 of the heat-driven atmospheric water generator 200 is shown in FIG. 3. The preconditioner 210 in present example includes a heat exchanger 302 and two sorption/desorption units or reactors, referred to herein as the first sorption/desorption unit 304 and the second sorption/desorption unit 306. Other numbers of sorption/desorption units may successfully be implemented.

After filtering utilizing the air filter 240, the ambient air 212 is split into two separate flows 308, 310. The heat exchanger 302 may be any suitable heat exchanger for indirect heat exchange between ambient air and a heat transfer fluid from a high temperature source, for example, the heated fluid 234 from the core atmospheric water generator 230. The heat exchanger 302 includes an inlet 312 for receiving the first flow 308 of the ambient air 212, and exchanging heat with the heated fluid 234 introduced into a shell 316 of the heat exchanger 302 via a heat transfer fluid line 318. Waste gas from industry may also be used with the heated fluid 234 in the heat transfer fluid line 318. The heat transfer fluid line 318 includes valves to control the flow of the heated fluid 234.

For the purpose of the present example, the heat exchanger 302 includes a thin-walled duct or tube 320 that includes thin-walled sides 322. The thin-walled sides 322 may also include turbulators or flappers, or both turbulators and flappers on an internal surface 324 of the thin-walled sides 322 of the duct or tube 320 and on an external surface 326 of the thin-walled sides 322. The thin-walled duct or tube 320 may be thin-walled metal, graphite, polymer, ceramic, or any suitable combination thereof.

The heated fluid 234 passes through a heat transfer fluid line 318 and into the shell 316 of the heat exchanger 302. The heated fluid 234 passes around the outside of the thin-walled duct or tube 320 and indirectly exchanges heat with the ambient air 212 that was split into the ambient air flow 308, through the body of the thin-walled duct or tube 320. The ambient air flow 308 is heated in the heat exchanger 302 by indirect heat exchange with the heated fluid 234 and the heated air 328 is introduced to the first sorption/desorption unit 304 through an air conduit.

The first sorption/desorption unit 304 includes a sorbent 330 on an inside surface of a thin-walled sorption vessel 332. The sorption vessel 332 may be metallized or metal-lined or made from other materials such as graphite, polymer, ceramic, glass, or any combination thereof with a thin coating and/or resin impregnation. A coating may be utilized to protect the surface against corrosion. Optionally, resin impregnation may be utilized to seal surface pores in porous or semi-porous wall materials such as graphite. In one example, the sorption vessel 332 is a thin-walled metallic-polymer vessel or passage.

In the example shown in FIG. 3 and described above, the sorbent 330 is disposed on the inside of the thin-walled sorption vessel 332. Alternatively, the sorbent 330 may be disposed on the outside of the thin-walled sorption vessel 332 and, in this alternative, heated fluid 234 passes through the interior.

The sorbent 330 is suitable to sorb and desorb water in vapor form. The sorbent 330 may be a highly porous solid with high thermal conductivity, low density, and low specific heat. For example, the sorbent 330 may have a specific pore volume of >1 cm³/g and specific surface area of >300 m²/g. The thermal conductivity may be greater than 0.2 W/mK. In some examples, the thermal conductivity may be greater than 1.5 W/mK. The sorbent 330 may include a solid sorbent material, a binder material, hygroscopic salt, and a conductive additive. The sorbent 330 has high gas diffusivity to facilitate permeation of the vapor into and out of the sorbent 330.

In one example, the sorbent 330 includes a highly porous matrix of, for example, silica gel. The host matrix is impregnated by hygroscopic salts such as calcium chloride or lithium bromide and is loaded with one or more types of suitable thermally conductive additive material such as graphite flakes, treated and modified expanded natural graphite, graphite worms, carbon nanotubes, or a combination thereof. A binder material of organic glue, inorganic glue, or liquid glass may be utilized to bind the elements together into a composite. In one example, a binder of Polyvinyl alcohol 130 (PVA130), is utilized to bind the elements together into a composite.

The sorbent 330 may be several micrometers to centimeters in thickness on the internal surface 324, providing a significant volume of sorbent 330 capable of sorbing water.

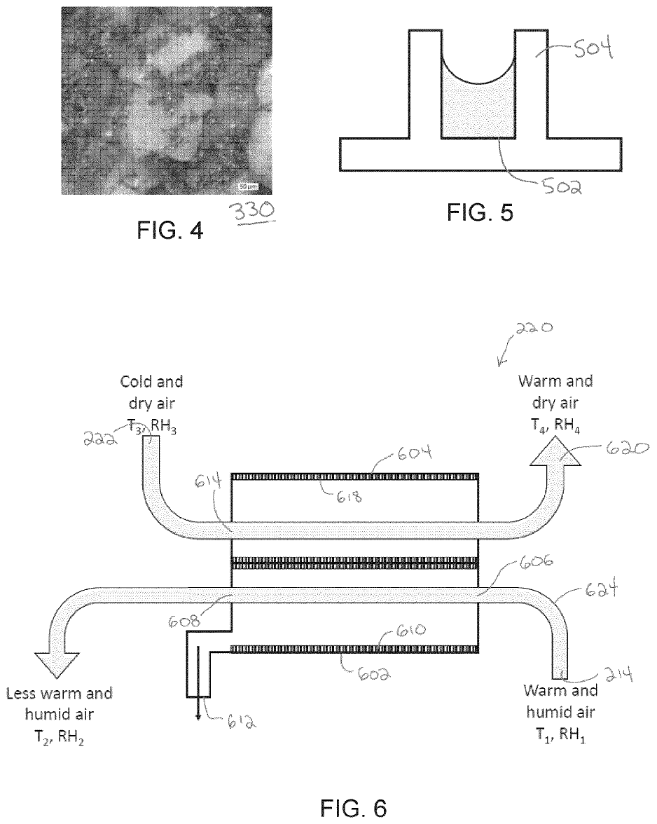

An example of a sorbent 330 for use in a sorption device is shown in FIG. 4. In this example, the sorbent 330 is a CaCl₂)-silica gel composite sorbent infused with expanded natural graphite or modified expanded natural graphite. A binder or glue of PVA130 is utilized.

In another example, a binder of Polyvinylpyrrolidone 40 (PVP40), is utilized to bind the elements together into a composite. In a particular example, the sorbent material is silica gel (B300) 58%; CaCl₂): 25%; Expanded natural graphite: 8%; PVA: 9%.

The sorbent material may be prepared in any suitable manner. The sorbent may be prepared by mixing binder with distilled water and a temperature of, for example, about 95° C. until the binder is fully dissolved. For example, the binder and distilled water way be mixed for about 1 to about 2 hours. Dry CaCl₂) is added to the binder solution and mixed, for example, for about 20 minutes until the CaCl₂) salt is dissolved. A thermal additive of, for example, expanded natural graphite is added to the solution and sonicated in a sonic back, for example, for about 30 minutes and stirred repetitively, for example, for about 2 hours. Silica gel matrix such as B300 is added to the mixture and mixed for about 30 minutes. The mixture is then transferred to a flat dish and evaporated to reach a consistency suitable for molding. The resulting composite is transferred to a mold of suitable shape for the application and dried in the oven, gradually increasing the temperature, for example, from about 80° C. to about 100° C. and then cured at, for example about 130° C. for about 2 hours.

Alternatively, the sorbent 330 may be a liquid. The surface 324 of the thin-walled sorption vessel 332 in this example includes a capillary surface pattern or modification to maintain the liquid sorbent on the surface 324. The pattern or modification may be formed by molding, coating, spraying, stamping, laser machining, etching, bead blasting, depositing, or any combination thereof.

Continued reference is made to FIG. 3 along with reference to FIG. 5, which shows an example of a surface pattern or modification and liquid sorbent. In this example, the internal surface 324 of the first sorption/desorption unit 304 includes channels 502 including protruding channel walls 504. Each of the channels 502 include liquid sorbent that is maintained therein by capillary and surface energy action. The liquid sorbent may be, for example, one or more of CaCl2, LiCl, and LiBr salt water solutions.

The first sorption/desorption unit 304 also includes formations 334 on a heat exchange fluid side, which in this example is the external surface of the thin-walled sorption vessel 332, and a shell 340 around the sorption vessel 332. The formations 334 may be turbulators or flappers, or both turbulators and flappers to facilitate heat exchange between the heated air 328 from the heat exchanger 302 and heated fluid 234 that pass through a heat exchange fluid line 338 and into the shell 340 around the sorption vessel 332 of the sorption/desorption unit 304. The heated fluid 234 from the core atmospheric water generator 230 is a high temperature heat exchange fluid. In addition, waste gas from industry may be utilized. The heated fluid 234 is introduced via the heat exchange fluid line 338. The heat exchange fluid line 338 includes valves, fans, and/or pumps to control the flow of the heated fluid 234.

The heated fluid 234 is introduced to the sorption/desorption unit via the heat exchange fluid line 338. The exchange fluid line 338 is fluidly coupled to the shell 340 of the first sorption/desorption unit 304 to direct the heated fluid 234 around the outside of the sorption vessel 332 and indirectly heat the sorbent 330 and the heated air 328. Heating of the sorbent 330 and the heated air 328 promotes desorption of water from the sorbent 330 to enhance the water content in the process air 214.

As indicated above, the preconditioner 310 also includes the second sorption/desorption unit 306. The second sorption/desorption unit 306 is similar to the first sorption/desorption unit 304. In particular, the second sorption/desorption unit 306 in this example includes a sorbent 350 on an inside surface 352 of a thin-walled sorption vessel 354. A shell 360 surrounds the thin-walled sorption vessel 354. The ambient air flow 310 that was split off after filtering in the air filter 240 is introduced to the second sorption/desorption unit 306 through an air conduit. Heat exchange fluids 356 are introduced to the second sorption/desorption unit 306 via a heat exchange fluid line 358. The exchange fluid line 358 is fluidly coupled to the shell 350 of the second sorption/desorption unit 306 to direct the heat exchange fluids 356 around the outside of the sorption vessel 352 and indirectly cool the sorbent 350. Thus, the heat exchange fluids 356 may be ambient temperature air, for example, to facilitate cooling of the sorbent 350 during sorption. Cooling of the sorbent 350 promotes sorption of water into the sorbent 350 from the ambient air flow 310.

As described above with reference to the first sorption/desorption unit, the sorbent 350 may alternatively be disposed on the outside of the thin-walled sorption vessel 352 and, in this alternative, the heat exchange fluids 356 passes through the interior.

In use, the ambient air flow 308 travels into and is heated in the heat exchanger 302 by indirect heat exchange with the heated fluid 234 to provide the heated air 328.

The heated air 328 is introduced into the thin-walled sorption vessel 332 where the heated air picks up moisture as the moisture is desorbed from the sorbent 330. The heated fluid 234 flows via the heat exchange fluid line 338, into the shell 340 and around the outside of the thin-walled sorption 332 to further heat the sorbent and promote desorption of water from the sorbent 330. The resulting increased moisture-containing air 214 is sent to the secondary atmospheric water generator 220.

As the first sorption/desorption unit is desorbing, providing the increased moisture-containing air 214, the second sorption/desorption unit is sorbing moisture. The ambient air flow 310 travels into the second sorption/desorption unit 306 and moisture from the ambient air flow 310 is sorbed by the sorbent 350 in the sorption vessel 352. The heat exchange fluids 356 that enter the shell 360 are utilized to cool the sorption vessel 352 as heat is generated as a result of the heat of sorption, and promoting sorption of the moisture into the sorbent 350. The dried air 362 from the second sorption/desorption unit 306 may be released to the atmosphere during charging, i.e., sorption of moisture.

When the second sorption/desorption unit 306 is charged, i.e., sufficient water is sorbed by the sorbent to facilitate humidification of heated air, or the first sorption/desorption unit is discharged, i.e., sufficient water is no longer desorbed into the heated air 328 from the heat exchanger, valves controlling the flow of the heated air 328 from the heat exchanger 302 and the heated fluid 234 and heat exchange fluids 356 are controlled to switch between the first sorption/desorption unit 304 and second sorption/desorption unit 306. Thus, the valves are switched such that the first sorption/desorption unit 304 and the second sorption/desorption unit 306 are effectively switched. In use, the first sorption/desorption unit 304 and second sorption/desorption unit 306 are cycled between sorption of water vapor and desorption of water vapor.

In the example shown in FIG. 3, two sorption/desorption units are shown. More than two sorption/desorption units may be utilized, however. For example, three or more sorption/desorption units may be utilized to facilitate continuous production of condensed water. Alternatively or in addition, more than one preconditioner 210 may be utilized. The valves referred to above that control the flow of the heated air 328 from the heat exchanger 302, the ambient air flow 308 and the ambient air flow 310, and the heated fluid 234 and heat exchange fluids 356 that are controlled to cycle between the first sorption/desorption unit 304 and second sorption/desorption unit 306 may be controlled by the controller 250.

A particle trap 364 is fluidly coupled to the first sorption/desorption unit 304 to receive the increased moisture-containing air 214 and to separate out any particles from the increased moisture-containing air 214. The increased temperature air is in contact with the sorbent to increase the moisture content of the air and produce the increased moisture-containing air. As a result, the increased moisture-containing air may include small particles of sorbent that are dislodged during the desorption or solid salt from the sorbent. The particle trap 364 traps such particles to inhibit fouling of the secondary atmospheric water generator 220 and the core atmospheric water generator 230.

Similarly, a particle trap 366 is fluidly coupled to the second sorption/desorption unit 306 to separate out any particles from the air coming from the second sorption/desorption unit 306. The air coming from the second sorption/desorption unit 306 is the dried air 362 during charging of the sorption vessel 362. When the sorption/desorption units 304, 306 are switched, increased humidity air comes from the second sorption/desorption unit 306 and dried air comes from the first sorption/desorption unit 304. The increased humidity air is sent to the secondary atmospheric water generator 220 and therefore is sent through the particle trap 366 to inhibit fouling of the secondary atmospheric water generator 220. Thus, the first sorption/desorption unit 304 and the second sorption/desorption unit 306 are interchangeable.

The particle traps 364, 366 are fluidly coupled to the secondary atmospheric water generator 220 to deliver the increased moisture-containing air 214 to the secondary atmospheric water generator 220. A schematic diagram of the secondary atmospheric water generator 220 is shown in FIG. 6.

The secondary atmospheric water generator 220 may be any suitable air to air type heat exchanger for indirect heat exchange between the increased moisture-containing air 214 and cooled air 222 from the core atmospheric water generator 230. In the example illustrated in FIG. 6, the heat exchanger is a counter-current heat exchanger including an increased moisture-containing air duct 602 and a cooled air duct 604. The heat exchanger may include a heat exchanger housing of thin-walled metal, graphite, polymer, ceramic, or any suitable combination thereof defining the increased moisture-containing air duct 602 and a cooled air duct 604.

The increased moisture-containing air duct 602 includes an inlet 606 that is fluidly coupled to the particle trap 364 or the particular trap 366 (shown in FIG. 3) and an outlet 608 that is fluidly coupled to the core atmospheric water generator 230 for the flow of the increased moisture-containing air 214 through the secondary atmospheric water generator 220. The increased moisture-containing air is delivered to the increased moisture-containing air duct 602 by an increased moisture containing air conduit 624.

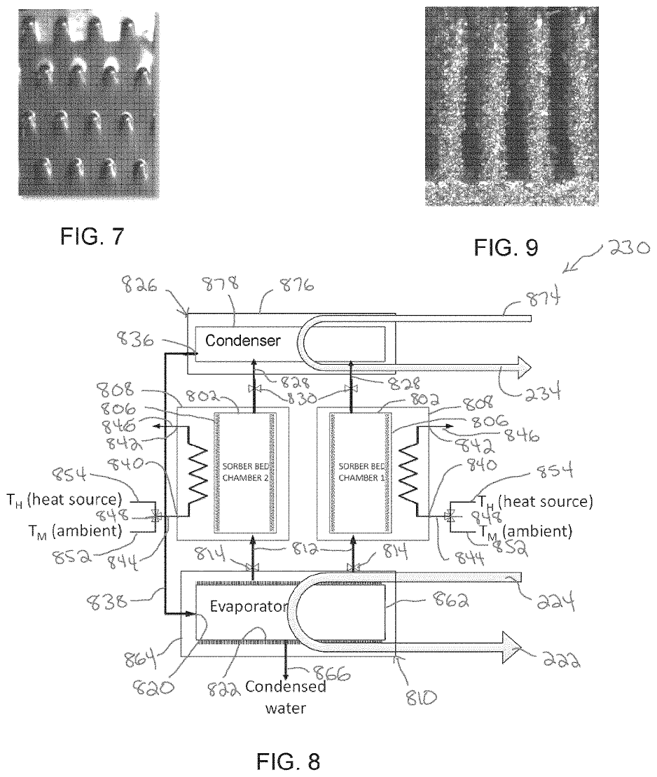

The interior surfaces 610 of the increased moisture-containing air duct 602 include a surface pattern or modification to facilitate drop-wise condensation of water on the interior surfaces 610. An example of a suitable surface pattern is shown in FIG. 7, in which asymmetric bumps are located on the surface. The bumps or other surface pattern may be formed utilizing any suitable technique such as molding, coating, spraying, stamping, laser machining, etching, deposition, bonding structures (such as micropillars, mesh, a porous structure), or a combination of these techniques.

The increased moisture-containing air duct 602 also includes a condensed water outlet 612 for the flow of water that condenses on the surface pattern or modification, by gravity, out of the increased moisture-containing air duct 602.

The cooled air duct 604 includes an inlet 614 that is fluidly coupled to the core atmospheric water generator 230, and an outlet 616 for expelling warmer air 620 after the cooled air 222 flows through and is heated in the cooled air duct 604.

The interior surfaces 618 of the cooled air duct 604 include turbulators or flappers, or both turbulators and flappers to facilitate heat exchange between the cooled air 222 and the increased moisture-containing air 214.

As the increased moisture-containing air 214 flows through the increased moisture-containing air duct 602, heat from the increased moisture-containing air 214 is transferred to the cooled air 222. The loss of heat from the increased moisture-containing air 214 promotes drop-wise condensation of the water on the interior surfaces of the 610 of the increased moisture-containing air duct 602 and the condensed water is collected from the condensed water outlet 612.

The cooled air 222 is heated and expelled as warmer air 620 from the outlet 616. The increased moisture-containing air 214 is cooled and exits the secondary atmospheric water generator 220 via the outlet 608 that is fluidly coupled to the core atmospheric water generator 230 for the flow of the reduced moisture-content air 224 to the core atmospheric water generator 230.

A schematic diagram of the core atmospheric water generator 230 is shown in FIG. 8. In the present example, the core atmospheric water generator 230 includes two sorber bed chambers 802. Additional sorber bed chambers may be successfully implemented, however. Each sorber bed chamber 802 has a sorbent material fixed to an internal surface of a wall 806 of the sorber bed chamber 802. The sorbent material is suitable to sorb and desorb the refrigerant in its vapor from. The wall 806 of the sorber bed chamber 802 may be a thin-walled material that is metallized or metal-lined or made from other materials such as graphite, polymer, ceramic, glass, or any combination thereof with a thin coating and/or resin impregnation or any combination thereof. Optionally, a coating may be utilized to protect the surface against corrosion. Optionally, resin impregnation may be used to seal the surface pores in porous or semi-porous wall materials such as graphite. In one example, the wall 806 of the sorber bed chamber 802 is a thin-walled metallic-polymer package or pouch. The sorbent material may be a solid as shown in FIG. 4 or may be a liquid maintained on a surface by capillary action. The surface may be patterned or include a surface modification to maintain the liquid sorbent. For example, the surface pattern or modification may be molded, coated, sprayed, stamped, laser machined, etched, bead blasted, or deposited. For example, the surface may include channels similar to that shown in FIG. 5.

Each sorber bed chamber 802 is housed in a respective housing 808 that extends around the sorber bed chamber 802. The wall 806 of the sorber bed chamber 802 provides a barrier between the interior of the sorber bed chamber 802 and the exterior of the sorber bed chamber 802. Thus, the sorber bed chamber 802 is hermetically sealed from a remainder of the interior of the housing 808 that surrounds the sorber bed chamber 802.

Each sorber bed chamber 802 is fluidly coupled to an evaporator 810 by a fluid line 812 for the flow of vapor from the evaporator 810 into the sorber bed chamber 802. The fluid line 812 extends through the housing 808 and into the sorber bed chamber 802, maintaining a seal or barrier between operating fluid in the fluid line 812 and the remainder of the interior of the housing 808 that surrounds the sorber bed chamber 802. Each fluid line 812 includes a respective valve 814 to control the flow of vapor from the evaporator 810 into the sorber bed chamber 802.

The evaporator 810 is configured to operate at a suitable pressure for evaporation of the refrigerant. The pressure may be a low pressure, i.e., a pressure well below atmospheric pressure. The pressure at which the evaporator operates at is dependent on the refrigerant utilized and operating conditions. The evaporator 810 includes an inlet 820 for receiving the refrigerant into the evaporator 810. Internal surfaces 822 of the evaporator 810 include a surface pattern or modification to facilitate capillary action of the refrigerant within the evaporator 810. The surface pattern or modification on the internal surfaces may be micro-grooves or may include the use of a wick, or both, that are sized to facilitate wicking of the refrigerant, providing super-hydrophilic surfaces. The grooves may be formed utilizing any suitable technique such as molding, coating, spraying, stamping, laser machining, etching, deposition, bead-blasting, bonding structures (such as micropillars, mesh, a porous structure), or a combination of these techniques.

An example of a surface of the evaporator 810 is shown in FIG. 9, in which a stainless steel is 3-D printed with 100 micron groves and surface structure to enhance wicking and thereby improve evaporation. The specific evaporation rate in an evaporator including the surface structure shown is increased significantly over the specific evaporation of an evaporator that does not include such surface structure.

Each sorber bed chamber 802 is also fluidly coupled to a condenser 826 by a respective vapor line 828 for the flow of vapor from the respective sorber bed chamber 802 to the condenser 826. Each vapor line 828 extends through the housing 808, from the respective sorber bed chamber 802 and into the condenser 826, maintaining a seal or barrier between operating fluid in the vapor line 828 and the remainder of the interior of the housing 808 that surrounds the sorber bed chamber 802. Each vapor line 828 includes a respective valve 830 to control the flow of vapor from the sorber bed chamber 802 into the condenser 826.

The condenser 826 is configured to condense the vapor from the sorber bed chamber 802 at a pressure that is higher than the pressure in the evaporator 810. In particular, the condenser 826 is configured to operate at a pressure that is suitable for the refrigerant to condense. The operating pressure in the condenser 826 is therefore dependent on the refrigerant and operating conditions. The condenser 826 includes a condenser outlet 836 for the flow of condensate from the condenser 826. The condenser outlet 836 is fluidly coupled to the evaporator inlet 820 by a refrigerant return line 838 for the return of the liquid refrigerant to the evaporator inlet 820.

Internal condenser surfaces include a surface pattern or modification to facilitate capillary action of the refrigerant within the condenser 826. The surface pattern or modification may be asymmetric bumps on the internal condenser surfaces to facilitate drop-wise condensation. The bumps may similar to those shown in FIG. 7 and may be formed utilizing any suitable technique such as molding, coating, spraying, stamping, laser machining, etching, deposition, bonding structures such as micropillars, mesh, a porous structure, or a combination of these techniques.

Similar to the sorber bed chamber 802, the outer wall of each of the evaporator 810 and the condenser 826 may be made of a thin-walled material that is metallized or metal-lined or made from other materials such as graphite, polymer, ceramic, glass, with thin coating and/or resin impregnation, or any combination thereof. Optionally, a coating may be utilized to protect the surface against corrosion and/or to modify or enhance the surface features such as contact angle. Optionally, resin impregnation may be used to seal the surface pores in porous and semi-porous wall materials such as graphite. In one example, each wall is a thin-walled metallic-polymer package or pouch.

Each housing 808 around the respective sorber bed chamber 802 includes a heat exchange fluid inlet 840 and a heat exchange fluid outlet 842. Each heat exchange fluid inlet 840 is coupled to a heat exchange fluid inlet line 844 that includes a three-way inlet valve 848 for selectively coupling the heat exchange fluid inlet line 844 to a first inlet line 852 and a second inlet line 854. Each heat exchange fluid outlet 842 is coupled to a respective heat exchange fluid outlet line 846.

Each first inlet line 852 may be utilized for the flow of a cooling fluid utilized to cool the respective sorber bed chamber 802 during sorption of the vapor from the evaporator to facilitate sorption by the sorber bed chamber 802 as the heat of sorption is generated. The cooling fluid may be, for example, ambient temperature water or water from a cooling tower, lake, or other source. Turbulators or flappers or both may be utilized in the housing 808 to facilitate effective heat transfer.

Each second inlet line 854 may be utilized for the flow of a regenerative heat exchange fluid to heat the respective sorber bed chamber 802 to facilitate desorption of the refrigerant vapor into the condenser 826. The regenerative fluid utilized to heat each sorber bed chamber 802 may be waste gasses from industry, solar heated fluid, geothermal heated fluid, or any other low grade heat fluid.

Thus, the cooling fluid may be an ambient temperature fluid that is introduced into each housing 808 via the first inlet line 852, the three-way inlet valve 848, and the heat exchange fluid inlet line 844 to exchange heat with the sorber bed chamber 802, to cool the sorbent material during sorption of the refrigerant vapor. The cooling fluid exits the housing 808 via the heat exchange fluid outlet line 846.

The regenerative fluid may be a waste gas or other low grade heat fluid that is selectively introduced into each housing 808 via the second inlet line 854, the three-way inlet valve 848, and the heat exchange fluid inlet line 844, to exchange heat with the sorber bed chamber 802, to heat the sorbent material in the sorber bed chamber 802. This heat exchange is utilized to facilitate desorption of the refrigerant from the sorbent material in the sorber bed chamber 802, thus regenerating the sorbent material to receive more vapor from the evaporator. The regenerative fluid exits the housing 808 via the heat exchange fluid outlet line 846.

The refrigerant that enters the evaporator 810 through the evaporator inlet 820 is maintained separate from the reduced moisture-content air 224. As the refrigerant evaporates under low pressure in the evaporator 810, a cooling effect is generated in the evaporator 810. The vapor from the refrigerant enters one of the sorber bed chambers 802 and is sorbed by the sorption material.

The reduced moisture-content air 224 from the secondary atmospheric water generator 220 is introduced to the housing 864 of the evaporator 810. Outer surfaces of the evaporator chamber 862 include a surface pattern or modification to facilitate drop-wise condensation of water. An example of a suitable surface pattern is shown in FIG. 7, in which bumps are located on the surface. The bumps or other surface pattern may be formed utilizing any suitable technique such as molding, coating, spraying, stamping, laser machining, etching, deposition, bonding structures (such as micropillars, mesh, a porous structure), or a combination of these techniques. The evaporator chamber 862 is a thin-walled material and facilitates heat exchange between the reduced moisture-content air 224 and the interior of the evaporator chamber 862, thus cooling the reduced moisture-content air 224. Turbulators of flappers may also be utilized to keep the moving fluid in turbulence to effect heat transfer.

Thus, the reduced moisture-content air 224 from the secondary atmospheric water generator 220 is introduced to the housing 864 of the evaporator 810, flows through the housing 864 while undergoing a cooling effect, promoting condensation of water on the outside of the evaporator chamber 862, and out an outlet of the evaporator housing 864.

A heating fluid line 874 extends through the condenser 826, through a housing 876 that houses a condenser chamber 878, and is maintained separate from the refrigerant that condenses in the condenser chamber 878. Heating fluid travelling through the condenser housing 876 in the heating fluid line 874 is heated as the refrigerant condenses in the condenser chamber 878. The heating fluid line then exits the condenser housing 876 with the resulting heated fluid 234 that is utilized in the preconditioner 210. Turbulators or flappers or both may be utilized in the condenser housing 876 to facilitate effective heat transfer. The heated fluid 234 is thus utilized in the preconditioner 210.

In use, the refrigerant, which may be water, inorganic salt water solution, or alcohol, for example, is introduced into the evaporator 810, which is at low pressure as referred to above. The refrigerant evaporates in the evaporator 810 and the vapor travels through one of the fluid lines 812 into the associated sorber bed chamber 802 where the vapor is sorbed by the sorbent material. As the refrigerant evaporates, a cooling effect occurs.

The cooling effect is utilized to cool the reduced moisture-content air 224 that travels through the housing 864 of the evaporator 810, further reducing the temperature and facilitating condensation of water. The condensed water from the evaporator flows by gravity and out the condensed water outlet 866, from which the condensed water is collected. The reduced moisture-content air is cooled and dried, providing the cooled air 222 that is utilized in the secondary atmospheric water generator 220.

As the vapors from the refrigerant are sorbed by the sorbent material, heat is generated by the heat of sorption. The cooling fluid is introduced into the housing 808 in which the sorption is occurring via the respective first inlet line 852, the three-way inlet valve 848, and the heat exchange fluid inlet line 844 to exchange heat with the sorber bed chamber 802, to cool the sorbent material during sorption of the vapors from the refrigerant. The cooling fluid exits the housing 808 via the heat exchange fluid outlet line 846.

When further vapor is no longer sorbed by the sorbent material or sorption slows, the valve 814 to that sorber bed chamber 802 is closed and the valve 830 in the vapor line 828 from that same sorber bed chamber 802 is opened. The three-way inlet valve 848 is switched to allow the regenerative fluid in from the second fluid inlet line 854, through the three-way valve 848 and the heat exchange fluid inlet line 844. The regenerative fluid flows out through the heat exchange fluid outlet line 846. Thus, the flow of the regenerative fluid is facilitated, adding low grade heat, for example, in some applications, regenerative fluid at less than 100° C. may be introduced into the housing 808, to promote desorption of the sorbed refrigerant vapor. The refrigerant vapor then travels into the condenser chamber 878 via the vapor line 828 where the refrigerant condenses and travels back to the evaporator chamber 862 via the refrigerant return line 838.

In addition, when further vapor is no longer sorbed by the sorbent material or sorption in the sorber bed chamber slows, the valves are switched to facilitate the flow of the vapor from the evaporator 810 into the other sorber bed chamber 802 and for the cooling fluid to enter the housing 808 that houses that other sorber bed chamber. Thus, while a first sorber bed chamber 802 is sorbing vapor from the evaporator 810, the second sorber bed chamber 802 is regenerated utilizing the regenerating fluid and vapors are introduced into the condenser chamber 878. When the first sorber bed chamber no longer sorbs vapor or slows, switching occurs and the second sorber bed chamber 802 is utilized for sorption of vapor from the evaporator 810 while the first is regenerated. Switching may occur quickly and automatically to provide a continuous cooling effect, thereby continuously cooling the reduced moisture-content air 224 and producing condensed liquid water 232 and the cooled air 222 as well has heated fluid 234. The controller 250 may control the valves to automatically switch between sorption and desorption for the two sorber bed chambers 802 or a separate controller may be utilized.

When utilizing the heat-driven atmospheric water generator 200, ambient air 212 flows through the air filter 240 and into the heat exchanger 302 where the ambient air 212 is heated by heat exchange with the heated fluid 234 in the heat transfer fluid line 318, providing the heated air 328. The heated air 328 enters the sorption/desorption unit 304 in which desorption of water from the sorbent 330 occurs as the sorbent 330 is heated by the heated air 328 and heated fluid 234. The water, in vapor form, that is desorbed from the sorbent 330, is picked up in the heated air 328, providing the increased moisture-containing air 214. The sorption/desorption unit 304 is cycled with a second sorption/desorption unit 306 such that one of the sorption/desorption units is charging while the other is discharging.

The increased moisture-containing air 214 enters the secondary atmospheric water generator 220 and exchanges heat with the cooled air 222 from the core atmospheric water generator 230. Thus, the increased moisture-containing air 214 is cooled and water from the increased moisture-containing air 214 condenses in the secondary atmospheric water generator 220, producing reduced moisture-content air 224. The condensed water is collected from the condensed water outlet 612.

The reduced moisture-content air 224 is further cooled in the evaporator 810 of the core atmospheric water generator 230 and more water condenses in the evaporator and is collected from the condensed water outlet 866. The resulting cooled air 222 is fed back and utilized in the secondary atmospheric water generator 220.

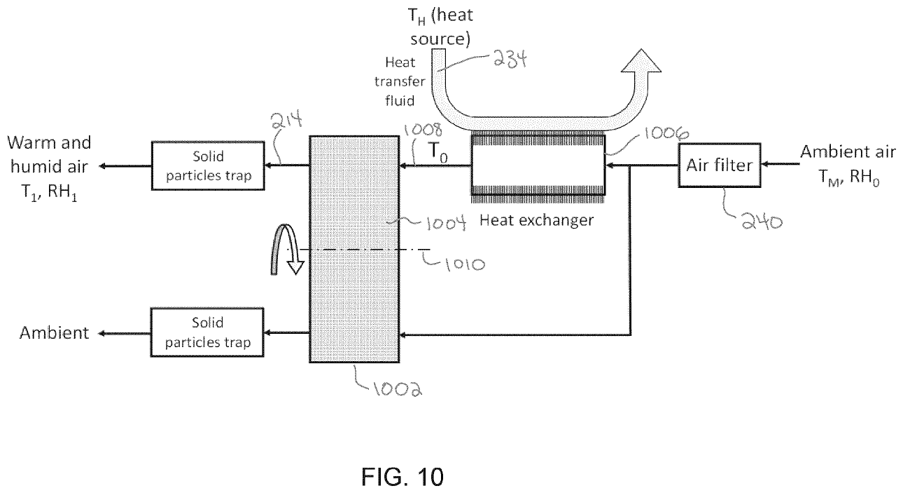

An alternative preconditioner of the heat-driven atmospheric water generator of FIG. 2 is shown in FIG. 10. The preconditioner in the present example includes many of the same features or elements as those shown and described above with reference to FIG. 3. In the present example, rather than two sorption/desorption units, a desiccant wheel 1002 is utilized. The desiccant wheel 1002 includes sorbent 1004 disposed therein.

Ambient air is subjected to filtering in the air filter 240 and is split into two ambient air flow streams, similar to that described with reference to FIG. 3. One of the ambient air flow streams is heated in the heat exchanger 1006 by heat exchange with the heated fluid 234. The heated air 1008 from the heat exchanger 1006 passes through one part of the desiccant wheel 1002, as the sorbent 1004 desorbs water vapor into the heated air 1008, providing the increased moisture-containing air 214.

The other ambient air flow stream passes through a different portion of the desiccant wheel 1002 and the sorbent 1004 in that part of the desiccant wheel 1002 sorbs water from the ambient air flow stream. Thus, one part of the desiccant wheel 1002 is charged or sorbs water while the other part of the desiccant wheel is discharged or desorbs water.

The desiccant wheel 1002 is rotated about a central axis 1010 to continually discharge or desorb water into the heated air 1008 by exposing a charged or partially charged portion of the desiccant wheel to the heated air 1008, providing a continuous stream of increased moisture-containing air 214, and to continually charge or sorb water by exposing a dry portion or portions of the desiccant wheel to ambient air.

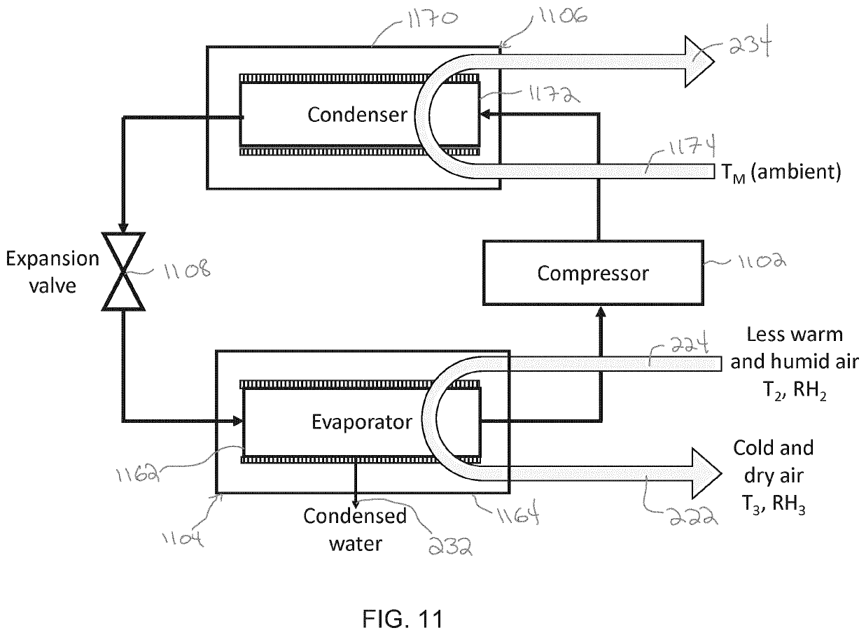

An alternative core atmospheric water generator 230 of the heat-driven atmospheric water generator of FIG. 2 is shown in FIG. 11. The core atmospheric water generator 230 in the present example utilizes the vapor compression refrigeration cycle.

The compressor 1102 sucks the refrigerant gas from the evaporator 1104 and after compression, discharges the high pressure and temperature gas toward the condenser 1106. Through the condenser 1106, the gas is condensed as a result of heat rejection to a secondary flow such as air or water, and a saturated or sub-cooled liquid goes to the expansion valve 1108. As a result of throttling through the expansion valve 1108, the pressure and temperature of the refrigerant drops and a low pressure and temperature two-phase refrigerant flows into the evaporator 1104.

The evaporator 1104 includes a housing 1164 that houses an evaporator chamber 1162 or coil. The refrigerant flows into the evaporator chamber 1162 and evaporates, providing a cooling effect.

Outer surfaces of the evaporator chamber 1162 include a surface pattern or modification to facilitate drop-wise condensation of water. An example of a suitable surface pattern is shown in FIG. 7, in which bumps are located on the surface. The bumps or other surface pattern may be formed utilizing any suitable technique such as molding, coating, spraying, stamping, laser machining, etching, deposition, bonding structures (such as micropillars, mesh, a porous structure), or a combination of these techniques.

The evaporator chamber 1162 may be a thin-walled material and facilitates heat exchange between the interior of the evaporator chamber 1162 and the reduced moisture-content air 224 that flows from the secondary atmospheric water generator 220 (shown in FIG. 2) through the evaporator housing 1164, thus further cooling the reduced moisture-content air 224 and condensing humidity, producing the liquid water 232 and the cooled air 222 that is utilized in the secondary atmospheric water generator 220 (shown in FIG. 2).

The evaporator chamber 1162 may also include turbulators or flappers or both to keep the reduced moisture-content air 224 moving in turbulence to ensure effective heat transfer.

Similarly, the condenser 1106 includes a housing 1170 that houses an condenser chamber 1172 or coil. The vapor refrigerant flows into the condenser chamber 1172 and condenses, providing heat to the fluid that travels through the housing 1170 as the fluid travelling through the housing 1170 exchanges heat with the condenser chamber 1172 where the refrigerant condenses and provides heat. The housing 1170 may include turbulators or flappers or both to keep the fluid 1174 moving in turbulence to ensure effective heat transfer. Thus, heated fluid 234 is produced from the condenser 1106.

The heated fluid 234 may be utilized in the preconditioning unit 210, for example, as the heated fluid 234 introduced into the shell 316 of the heat exchanger 302 via a heat transfer fluid line 318, as shown in FIG. 3 and/or the heated fluid 234 that pass through the heat exchange fluid line 338 and into the shell 340 around the sorption vessel 332.

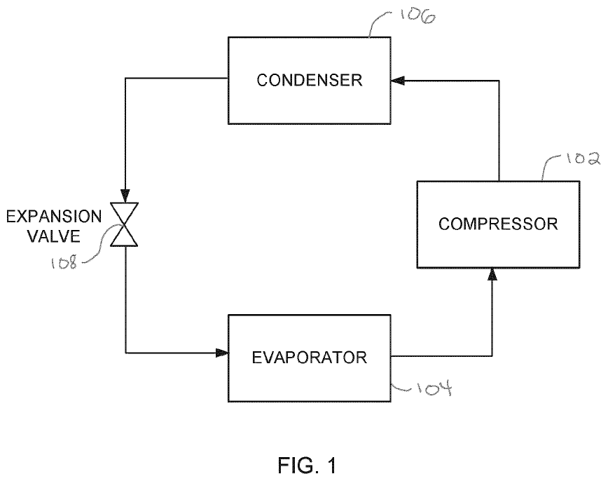

A heat-driven atmospheric water generator as illustrated in FIG. 2 was developed and testing results by way of comparison of the heat-driven atmospheric water generator (referred to as HAWgen) to a prior art water generator (referred to as Convention AWG) as illustrated in FIG. 1 are included below in Table 1.

TABLE 1
Test Result comparison of heat-driven atmospheric
water generator to prior art water generator

| | | Water | Compressor | Energy* | Cost** |
|---|---|---|---|---|---|
| | | Generation | Power | (kWh/ | (cents/ |
| Test condition | Unit | (liters/day) | (W) | liter) | liter) |
| 33° C., | Conventional AWG | 3.3 | 774 | 5.6 | 63 |
| 18% Relative Humidity | HAWgen | 13.7 | 1,018 | 1.8 | 20 |
| (Arizona, US, Summer) | | | | | |
| 32° C., | Conventional AWG | 15.7 | 785 | 1.2 | 13.5 |
| 55% Relative Humidity | HAWgen | 27.6 | 1,023 | 0.89 | 10 |
| (Florida, US, Summer) | | | | | |
| 25° C., | Conventional AWG | 6.9 | 706 | 2.5 | 28 |
| 48% Relative Humidity | HAWgen | 23.2 | 985 | 1.0 | 11 |
| (British Columbia, | | | | | |
| Canada, Summer) | | | | | |
| 6° C., | Conventional AWG | Did not work under these conditions | | | |
| 80% Relative Humidity | HAWgen | 15.9 | 905 | 1.4 | 16 |
| (British Columbia, | | | | | |
| Canada, Winter) | | | | | |

Advantageously, the heat-driven atmospheric water generator facilitates the recovery of water from the atmosphere, even in dry regions. The water may be recovered from the atmosphere utilizing waste heat from industry. By preconditioning air to heat the air and increase humidity in a sorption/desorption unit, water is recoverable in a secondary atmospheric water generator, followed by a core atmospheric water generator. The core atmospheric water generator provides cool air for use in the secondary atmospheric water generator and heated fluid for use in the preconditioner. The secondary atmospheric water generator and core atmospheric water generator may be operated continuously, utilizing multiple sorber bed chambers in the core atmospheric water generator to continuously produce water.

The scope of the claims should not be limited by the preferred embodiments set forth in the examples, but should be given the broadest interpretation consistent with the description as a whole.

What is claimed is:

1. A heat-driven atmospheric water generator comprising:
a preconditioner configured to increase temperature and moisture content of ambient air, providing increased moisture-containing air;
a secondary atmospheric water generator fluidly coupled to the preconditioner to receive the increased moisture-containing air and configured to reduce the air temperature and humidity by heat exchange with cooled air, providing a reduced moisture-content air and producing condensed liquid water;
a core atmospheric water generator having an inlet fluidly coupled to the secondary atmospheric water generator to receive the reduced moisture-content air and configured to further reduce temperature and humidity, producing condensed liquid water and the cooled air that is utilized in the secondary atmospheric water generator.

2. The heat-driven atmospheric water generator according to claim 1, wherein the core atmospheric water generator comprises an evaporator coupled to a sorption bed, wherein the evaporator is fluidly coupled to the secondary atmospheric water generator to receive the reduced moisture-content air and to produce the condensed liquid water and the cooled air utilized in the secondary atmospheric water generator.

3. The heat-driven atmospheric water generator according to claim 2, wherein the sorption bed includes a sorbent material disposed therein and is configured to sorb and desorb vapor from a refrigerant utilized in the evaporator.

4. The heat-driven atmospheric water generator according to claim 3, comprising a condenser fluidly coupled to the sorption bed for the flow of vapor desorbed from the sorption bed, into the condenser and condensation of the vapor to liquid refrigerant, the condenser in fluid communication with the evaporator for the flow of the refrigerant from the condenser after condensation, to the evaporator.

5. The heat-driven atmospheric water generator according to claim 4, wherein the sorption bed is configured to exchange heat with a regenerative fluid to effect desorption of the refrigerant from the sorbent material.

6. The heat-driven atmospheric water generator according to claim 5, wherein the regenerative fluid comprises a waste gas or fluid.

7. The heat-driven atmospheric water generator according to claim 3, wherein the sorbent material comprises a solid sorbent, hygroscopic salt, a binder material, and a conductive additive.

8. The heat-driven atmospheric water generator according to claim 2, wherein the sorption bed is housed in a thin film of ceramic or polymer-metal foil laminate.

9. The heat-driven atmospheric water generator according to claim 2, wherein the evaporator comprises a housing of thin-walled metal, graphite, polymer, ceramic, or any combination thereof.

10. The heat-driven atmospheric water generator according to claim 1, wherein the secondary atmospheric water generator comprises a heat exchanger to facilitate indirect heat exchange between the increased moisture-containing air and the cooled air from the evaporator.

11. The heat-driven atmospheric water generator according to claim 1, wherein the preconditioner comprises a heat exchanger for indirect heat exchange between a heated fluid source and ambient air to increase temperature of the ambient air, thereby providing heated air.

12. The heat-driven atmospheric water generator according to claim 11, wherein the heated fluid source comprises waste gasses.

13. The heat-driven atmospheric water generator according to claim 11, wherein the preconditioner comprises a sorption/desorption unit configured to absorb water, and to desorb the water into the heated air, providing the increased moisture-containing air.

14. The heat-driven atmospheric water generator according to claim 1, comprising a controller coupled to components of the preconditioner, the secondary atmospheric water generator, and the core atmospheric water generator, and configured to control the components based on one or more atmospheric conditions.

15. The heat-driven atmospheric water generator according to claim 14, comprising one or more sensors configured to monitor the one or more atmospheric conditions.

16. The heat-driven atmospheric water generator according to claim 15, wherein the one or more sensors comprise one or both of an ambient air temperature sensor and an ambient air moisture content sensor.

17. The heat-driven atmospheric water generator according to claim 14, wherein the controller is configured to monitor operating parameters of at least one of the preconditioner, the secondary atmospheric water generator, and the core atmospheric water generator.

18. The heat-driven atmospheric water generator according to claim 17, wherein the operating parameters comprise one or more of speed of one or more fans, cooling and heating capacity of one or more heat exchangers of the preconditioner, capacity of one or more heat exchangers of the secondary atmospheric water generator, speed of a desiccant wheel of the preconditioner, and capacity of the core atmospheric water generator.

19. The heat-driven atmospheric water generator according to claim 13, wherein the sorption/desorption unit comprises a desiccant wheel configured to rotate to expose dry portions of the desiccant wheel to a charging air stream to absorb water and to expose a moisture-laden portion of the desiccant wheel to the increased temperature air, to desorb water and provide the increased moisture-containing air.

20. The heat-driven atmospheric water generator according to claim 13, wherein the sorption/desorption unit comprises a sorption/desorption shell of thin-walled metal, graphite, polymer, ceramic, or any combination thereof.

21. The heat-driven atmospheric water generator according to claim 13, wherein the heat exchanger comprises a heat exchanger shell of thin-walled metal, graphite, polymer, ceramic, or any combination thereof.

22. The heat-driven atmospheric water generator according to claim 10, wherein the heat exchanger of the secondary atmospheric water generator comprises a heat exchanger housing of thin-walled metal, graphite, polymer, ceramic, or any combination thereof.

23. The heat-driven atmospheric water generator according to claim 1, wherein the preconditioner includes one or both of turbulators and flappers on at least one of an internal surface and an external surface thereof.

24. The heat-driven atmospheric water generator according to claim 1, wherein the secondary atmospheric water generator includes one or both of turbulators and flappers on an internal surface thereof.

25. The heat-driven atmospheric water generator according to claim 1, wherein an internal surface of the sorption bed of the core atmospheric water generator includes a capillary surface pattern or modification to facilitate capillary action of liquid sorbent inside.

26. The heat-driven atmospheric water generator according to claim 25, wherein the capillary surface pattern or modification comprises at least one of molded, coated, sprayed, stamped, laser machined, etched, bead blasted, and deposited surface pattern or modification.

27. The heat-driven atmospheric water generator according to claim 1, wherein an internal surface of the sorption/desorption unit of the preconditioner includes a capillary surface pattern or modification to facilitate capillary action of liquid sorbent inside.

28. The heat-driven atmospheric water generator according to claim 27, wherein the capillary surface pattern or modification comprises at least one of molded, coated, sprayed, stamped, laser machined, etched, bead blasted, and deposited surface pattern or modification.

29. The heat-driven atmospheric water generator according to claim 1, wherein the core atmospheric water generator is configured to produce heated fluid that is utilized in the preconditioner.
